(19) United States
(12) Patent Application Publication
(10) Pub. No.: US 2011/0052937 A1
(43) Pub. Date: Mar. 3, 2011

(54) COPPER-ZINC ALLOY ELECTROPLATING BATH AND PLATING METHOD USING THE SAME

(75) Inventor: Hiroshi Kanno, Kodaira-shi (JP)

(73) Assignee: BRIDGESTONE CORPORATION, Chuo-ku, Tokyo (JP)

(21) Appl. No.: 12/991,634

(22) PCT Filed: May 12, 2009
(86) PCT No.: PCT/JP2009/058839

§ 371 Date: Nov. 8, 2010

(30) Foreign Application Priority Data
May 12, 2008 (JP) 2008-124446

(51) Int. Cl. B32B 15/01; C25D 3/58; B32B 15/02

(52) U.S. Cl. 428/659; 205/240

(57) ABSTRACT

Disclosed is a cyanide-free copper-zinc alloy electroplating bath which can form a uniform and glossy plated layer having the desired composition in a large current density range, and a plating method using the same.

The copper zinc alloy electroplating bath contains a copper salt, a zinc salt, an alkali metal pyrophosphate or an alkali metal tartrate, and nitrate ions. The concentration of the nitrate ions is preferably 0.001 to 0.050 mol/L. Further, the pH of the copper-zinc alloy electroplating bath is preferably in the range of 8 to 14. Furthermore, in addition to the copper salt, the zinc salt, the alkali metal pyrophosphate and the nitrate ions, at least one selected from amino acids or salts thereof is preferably included, and histidine can be used favorably as the amino acid.

### TECHNICAL FIELD

The present invention relates to a copper-zinc alloy electroplating bath and a plating method using it; more particularly, a cyanide-free copper-zinc alloy electroplating bath which can form a uniform and glossy copper-zinc alloy-plated layer having the desired composition in a large current density range, and a plating method using it.

### BACKGROUND ART

At present, copper-zinc alloy plating is industrially widely used as decorative plating to give a brass-colored metallic luster and tone to metal products, plastic products, ceramic products and the like. However, since a conventional plating bath contains a large amount of cyanide, its toxicity has become a big problem, and the burden of disposal of cyanide-containing waste has been large.

As means for solving these problems, a number of methods for copper-zinc alloy electroplating wherein no cyanide is used have been reported up to now. For example, sequential plating is a practical method for application of brass plating to a product to be plated, and in such a method, a copper-plated layer and a zinc-plated layer are sequentially plated on the surface of the product to be plated by electrodeposition, followed by a thermal diffusion step. In the case of sequential brass plating, a pyrophosphate copper plating solution and an acidic zinc sulfate plating solution are usually used (e.g., Patent Document 1).

On the other hand, as a method for simultaneous plating with copper-zinc, a cyanide-free copper-zinc alloy electroplating bath has also been reported, and a plating bath using a tartrate bath or a potassium pyrophosphate bath supplemented with histidine as a complexing agent has been proposed (e.g., Patent Document 2).

### RELATED ART REFERENCE

### Patent Documents

Patent Document 1: Japanese Unexamined Patent Application Publication No. 5-98496

Patent Document 2: Japanese Examined Patent Application Publication No. 3-20478

### DISCLOSURE OF THE INVENTION

### Problems To Be Solved By the Invention

However, sequential plating as described in Patent Document 1 has a drawback in that it requires a number of processing steps such as a copper-plated layer formation step, zinc-plated layer formation step and thermal diffusion step, and is hence complicated, so that the operating efficiency is poor. Further, in the copper-zinc alloy electroplating bath described in Patent Document 2, although there is no problem of toxicity which arises when a bath using cyanide is employed, since a lot of hydrogen is generated and it adheres to a surface of a plated layer during plating, supply of metal ions to the part is obstructed, and the surface of the plated layer becomes sparse, so that the uniformity and gloss are impaired. Consequently, decorative characteristics and functionalities of the material to be plated are reduced. Moreover, compared with a current density required for formation of the plated layer with high productivity, an available current density is small which is problematic. Therefore, in either case, at present, it is difficult to put a cyanide-free copper-zinc alloy electroplating bath to practical use.

Thus, an object of the present invention is to provide a cyanide-free copper-zinc alloy electroplating bath which can form a uniform and glossy copper-zinc alloy-plated layer having the desired composition in a large current density range, and a plating method using it.

### Means For Solving the Problems

To solve the above-described problems, the present inventor intensively studied to discover that, by plating with a copper-zinc alloy electroplating bath which has a following composition, generation of hydrogen during plating can be controlled, and a uniform and glossy copper-zinc alloy-plated layer having the desired composition can be formed in the range from a low current density to a high current density, thereby completing the present invention.

That is, the copper-zinc alloy electroplating bath of the present invention comprises a copper salt, a zinc salt, an alkali metal pyrophosphate or an alkali metal tartrate, and nitrate ions.

In the present invention, the concentration of the nitrate ions is preferably 0.001 to 0.050 mol/L; and the pH of the copper-zinc alloy electroplating bath is preferably in the range of 8 to 14. Further, in addition to the copper salt, the zinc salt, the alkali metal pyrophosphate and the nitrate ions, at least one selected from amino acids or salts thereof is preferably added; and as the amino acid, histidine can be favorably used.

Further, the copper-zinc alloy electroplating method of the present invention comprises electroplating at a current density in the range of 2 A/dm² to 14 A/dm² with the use of the above-mentioned copper-zinc alloy electroplating bath of the present invention.

Furthermore, the wire for steel codes of the present invention comprises a copper-zinc alloy-plated layer formed by the above-mentioned copper-zinc alloy electroplating method of the present invention.

### Effects of the Invention

According to the present invention, a cyanide-free copper-zinc alloy electroplating bath which can form a uniform and glossy copper-zinc alloy-plated layer having the desired composition in a large current density range, and a plating method using it can be provided.

### BEST MODE FOR CARRYING OUT THE INVENTION

Preferred embodiments of the present invention will be described in detail.

The copper-zinc alloy electroplating bath of the present invention contains a copper salt, a zinc salt, and an alkali metal pyrophosphate or an alkali metal tartrate, and further, nitrate ions exist in it. In the plating bath of the present invention, a mechanism which can form a uniform and glossy copper-zinc alloy-plated layer with the desired composition in a large current density range can be considered as follows.

In the plating bath, it is considered that reactions expressed by the following formulae (I) and (II) proceed.

2H⁺+2e⁻→H₂ (1)

NO₃⁻+H₂O+2e⁻→NO₂−2OH⁻ (II)

Under the condition where nitrate ions do not exist, since the reaction of the formula (I) proceeds competitively with a deposition of metal, hydrogen gas generates and adheres to a surface of an electrode. As a result, supply of metal ions to this part is obstructed, and roughness of the surface of the plated layer subjected to plating treatment for predetermined time increases, and also the inside of the plated layer becomes sparse, and thus a uniform plated layer can not be obtained. On the other hand, under the condition where nitrate ions exist in the plating bath, the reaction of the formula (II) proceeds preferentially to the reaction of the formula (I) with deposition of metal. Here, since a product of the formula (II) is NO₂⁻, it detaches immediately from the surface of the electrode, so that the deposition of metal is not obstructed. Therefore, it is considered that the surface of the plated material subjected to plating treatment for predetermined time is flat and smooth, so that the obtained plated layer is dense. In addition, in the present invention, a nitrate used is not especially restricted; any one can be employed as long as it is known.

The concentration of the nitrate ions in the plating bath of the present invention is preferably in the range of 0.001 to 0.050 mol/L. If the concentration of the nitrate ions is higher than 0.050 mol/L, a lot of electricity is consumed by reduction reaction of the nitrate ions, and since the current to be used for a plated layer formation decreases, the productivity of the plated layer reduces. On the other hand, if the concentration of the nitrate ions is lower than 0.001 mol/L, the control of the generation of hydrogen is insufficient, so that the effect of the present invention can not be acquired sufficiently.

Further, the pH of the plating bath of the present invention is preferably in the range of 8 to 14. If the pH is lower than 8, the copper deposits preferentially, so that it becomes difficult to obtain a copper-zinc alloy plating with the desired composition. On the other hand, if the pH is higher than 14, the precipitation of metal salt occurs, so that it becomes impossible to acquire the effect of the present invention sufficiently.

As the copper salt, any one can be employed as long as it is known as a copper ion source for plating baths, and examples thereof include copper pyrophosphate, copper sulfate, cupric chloride, copper sulfamate, cupric acetate, basic copper carbonate, cupric bromide, copper formate, copper hydroxide, cupric oxide, copper phosphate, copper silicofluoride, copper stearate and cupric citrate, and either only one of these or two or more of these may be used.

As the zinc salt, any one can be employed as long as it is known as a zinc ion source for plating baths, and examples thereof include zinc pyrophosphate, zinc sulfate, zinc chloride, zinc sulfamate, zinc oxide, zinc acetate, zinc bromide, basic zinc carbonate, zinc oxalate, zinc phosphate, zinc silicofluoride, zinc stearate and zinc lactate, and either only one of these or two or more of these may be used.

In the present invention, it is essential to use either an alkali metal pyrophosphate or an alkali metal tartrate as a complexing agent. As the alkali metal pyrophosphate and the alkali metal tartrate, any one can be employed as long as it is known, and examples thereof include potassium pyrophosphate and sodium·potassium tartrate tetrahydrate.

Further, in the present invention, in addition to the copper salt, the zinc salt, the alkali metal pyrophosphate and the nitrate ions, at least one selected from amino acids or salts thereof is preferably added. A metal ion is complexed by an amino group and a carboxyl group which the amino acid has, so that the metal ion can exist stably. Therefore, when a tartaric acid is used as a complexing agent, it is not necessary to add the amino acid. As the above-mentioned amino acid, any one can be employed as long as it is known, and examples thereof include αamino acids such as glycine, alanine, glutamic acid, aspartic acid, threonine, serine, proline, tryptophan and histidine, and hydrochlorides and sodium salts thereof. Among these histidine and histidine salts are preferred.

The amount of each of the above-described components to be added in the copper-zinc alloy electroplating bath of the present invention is not limited and may be selected appropriately. In consideration of industrial usage, the amount of the copper salt is preferably about 2 to 40 g/L in terms of copper; the amount of the zinc salt is preferably about 0.5 to 30 g/L in terms of zinc; when the alkali metal pyrophosphate is used as the complexing agent, the amount of the alkali metal pyrophosphate is preferably about 150 to 400 g/L; when the alkali metal tartrate is used as the complexing agent is used, the amount of the alkali metal tartrate is preferably about 50 to 400 g/L; and when the amino acid or a salt thereof is used, the amount of the amino acid or a salt thereof is preferably about 0.2 to 50 g/L.

Then, the copper-zinc alloy electroplating method of the present invention will be described.

The copper-zinc alloy electroplating method of the present invention comprises electroplating at a current density in the range of 2 A/dm² to 14 A/dm² using the above-mentioned copper-zinc alloy electroplating bath of the present invention. By controlling the current density in the range of 2 A/dm² to 14 A/dm², a uniform and glossy copper-zinc alloy-plated layer can be formed. Moreover, the composition of the copper-zinc alloy-plated layer is not influenced, even if the current density fluctuates within the above-mentioned range.

In the plating method of the present invention, a conventional electroplating conditions can be employed except for the current density. For example, the electroplating may be carried out at a bath temperature of about 30 to 40° C. without stirring, with mechanical stirring or with air agitation. In this case, as an anode, any one may be used as long as it is one used for conventional electroplating of a copper-zinc alloy.

Before carrying out the above-mentioned electroplating, the material to be plated may be subjected to conventional pretreatments such as buffing, degreasing, and soaking in a dilute acid according to conventional methods, or an undercoat plating such as gloss nickel plating may be also applied to the material. After the plating, a conventional operation such as washing with water, washing with hot water or drying may be carried out, and soaking in a dichromic acid dilute solution, clear painting or the like may be further carried out as required.

In the present invention, the material to be plated is not limited, and any one to which a copper-zinc alloy electroplating coat can be usually applied may be used. Examples thereof include metal products such as steel wires used in steel cords for reinforcing rubber articles; plastic products; and ceramic products.

### EXAMPLE

The present invention will be described in more detail by way of Examples below.

### Examples 1 To 7, Comparative Examples 1 And 2

According to the composition of the copper-zinc alloy electroplating bath shown in each Table 1 and 2 below, the copper-zinc alloy electroplating baths of Examples 1 to 7 and Comparative examples 1 and 2 were prepared, and copper-zinc alloy electroplating was carried out in accordance with the plating conditions shown in Tables 1 and 2. Plating deposition efficiency and Ra ratio were used for evaluation of the plating baths. The obtained results are also shown in the Tables 1 and 2 below.

### Plating Deposition Efficiency (%)

The ratio of an actual amount of deposition to an amount of theoretical deposition is expressed by percentage. It means that the larger this value is, the smaller the amount of generation of hydrogen is, so that a uniform and glossy plated layer can be formed, and a productivity of the plated layer is also excellent due to a few energy losses.

### Ra Ratio

Ra ratio was calculated by Ra ratio=(Ra before plating)/(Ra after plating), using Ra calculated according to the following equation;

$$Ra = \frac{1}{L} {\int }_{0}^{L} \vert f ( x ) \vert d x$$

which is the centerline average roughness (Ra) of the surface of the material to be plated before and after plating treatment. For calculation of the centerline average roughness, a portion of the roughness profile, which portion had a measurement length L in the direction of its centerline, was sampled, and the centerline of the sampled portion was taken along the x-axis and the longitudinal magnification direction was taken along the y-axis to represent the roughness profile as y=f(x). The value Ra given by the above equation was represented in micrometers (μm). It means that the larger the value of Ra ratio is, the smoother the surface of the plated layer after plating treatment is, so that the plated layer having an excellent gross is formed.

TABLE 1

| | | Example | Example | Example | Example | Example |
|---|---|---|---|---|---|---|
| | | 1 | 2 | 3 | 4 | 5 |
| Mass ratio | Copper sulfate (g/L) | 25.1 | 25.1 | 25.1 | 25.1 | 25.1 |
| of bath | Zinc sulfate (g/L) | 20.2 | 20.2 | 20.2 | 20.2 | 20.2 |
| | Complexing | A*¹ | A*¹ | A*¹ | B*² | B*² |
| | agent 1 (g/L) | 347.7 | 347.7 | 347.7 | 60 | 120 |
| | Complexing | L-histidine | L-histidine | L-histidine | — | — |
| | agent 2 (g/L) | hydrochloride | hydrochloride | 15.5 | | |
| | | 2.1 | 2.1 | | | |
| | Nitrate ion (mol/L) | Nitric acid | Sodium nitrate | Potassium | Sodium | sodium |
| | | 0.001 | 0.050 | nitrate | nitrate | nitrate |
| | | | | 0.005 | 0.010 | 0.020 |
| Plating | pH | 9.7 | 9.7 | 9.6 | 13 | 14 |
| conditions | pH adjusting reagent | KOH | KOH | KOH | NaOH | NaOH |
| | Bath temperature (° C.) | 30 | 40 | 30 | 40 | 50 |
| | Current density range | 2-14 | 2-14 | 2-14 | 2-14 | 2-14 |
| | (A/dm²) | | | | | |
| Evaluation | Plating deposition | 85 | 78 | 73 | 95 | 92 |
| | efficiency (%) | | | | | |
| | Ra ratio (μm/μm) | 1.86 | 1.64 | 2.10 | 1.76 | 1.67 |

*¹A: Potassium pyrophosphate
*²B: Sodium · potassium tartrate tetrahydrate

TABLE 2

| | | Comparative | Comparative | | |
|---|---|---|---|---|---|
| | | example 1 | example 2 | Example 6 | Example 7 |
| Mass ratio | Copper sulfate (g/L) | 25.1 | 25.1 | 25.1 | 25.1 |
| of bath | Zinc sulfate (g/L) | 20.2 | 20.2 | 20.2 | 20.2 |
| | Complexing | A*¹ | B*² | A*¹ | B*² |
| | agent 1 (g/L) | 347.7 | 120 | 347.7 | 120 |
| | Complexing | L-histidine | — | L-histidine | — |
| | agent 2 (g/L) | hydrochloride | | hydrochloride | |
| | | 2.1 | | 2.1 | |
| | Nitrate ion (mol/L) | — | — | Nitric acid | Potassium |
| | | | | 0.0008 | nitrate |
| | | | | | 0.060 |
| Plating | pH | 9.2 | 14 | 9.2 | 14 |
| conditions | pH adjusting reagent | KOH | NaOH | KOH | NaOH |
| | Bath temperature (° C.) | 30 | 50 | 30 | 50 |
| | Current density range | 2-6 | 2-5 | 2-10 | 2-12 |
| | (A/dm²) | | | | |
| Evaluation | Plating deposition | 53 | 86 | 48 | 19 |
| | efficiency (%) | | | | |
| | Ra ratio (μm/μm) | 0.82 | 0.93 | 1.14 | 1.12 |

Comparing the results of the Examples 1 to 7 with those of Comparative examples 1 and 2 in the above tables, it turned out that by having the composition of the copper-zinc alloy electroplating bath according to the present invention, a uniform and glossy plated layer with the desired composition can be formed. Moreover, it was confirmed that plating can be performed in a large current density range by using the bath.

1. A copper-zinc alloy electroplating bath comprising a copper salt, a zinc salt, an alkali metal pyrophosphate or an alkali metal tartrate, and nitrate ions.

2. The copper-zinc alloy electroplating bath according to claim 1, wherein the concentration of said nitrate ions is 0.001 to 0.050 mol/L.

3. The copper-zinc alloy electroplating bath according to claim 1, wherein the pH thereof is in the range of 8 to 14.

4. The copper-zinc alloy electroplating bath according to claim 1, comprising at least one selected from amino acids or salts thereof, in addition to the copper salt, the zinc salt, the alkali metal pyrophosphate and the nitrate ions.

5. The copper-zinc alloy electroplating bath according to claim 4, wherein said amino acid is histidine.

6. A copper-zinc alloy electroplating method, comprising electroplating at a current density in the range of 2 A/dm² to 14 A/dm²with the use of the copper-zinc alloy electroplating bath according to claim 1

7. A wire for steel codes comprising a copper-zinc alloy-plated layer formed by the copper-zinc alloy electroplating method according to claim 6.
